(19) United States
(12) Patent Application Publication
(10) Pub. No.: US 2008/0109771 A1
(43) Pub. Date: May 8, 2008

(54) PARAMETER CALCULATION APPARATUS, METHOD AND STORAGE MEDIUM

(75) Inventor: Sachiko Furuya, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/846,751

(22) Filed: Aug. 29, 2007

(30) Foreign Application Priority Data
Nov. 6, 2006 (JP) 2006-300943

(51) Int. Cl. G06F 17/50

(52) U.S. Cl. 716/4

(57) ABSTRACT

The present invention obtains a plurality of existing parameters each with a different frequency, select a frequency whose parameter should be calculated and calculates a parameter in the selected frequency, using the plurality of obtained existing parameters with different frequencies. Thus, at least one of the parameter of a frequency not prepared in a circuit and a parameter which a circuit obtained by connecting a plurality of such circuits or by connecting a plurality of types of circuits should be prepared is newly generated.

### BACKGROUND OF THE INVENTION

1. Field of the Invention

The present invention relates to a technology for calculating a parameter indicating the characteristic of a circuit prepared according to frequency.

2. Description of the Related Art

FIG. 1 shows the general flow of the development of an electric product. As shown in FIG. 1, the development is gradually progressed in the order of design analysis/performance evaluation prototype manufacturing actual measurement/performance check. Only a product that can be confirmed to be appropriate by the actual measurement/performance check thus are shipped.

As to an electric product, recently high-speed transmission has been promoted, and in the characteristic evaluation of each device used in the product, the device is regarded as a distributed constant circuit instead of a lumped constant circuit. Its characteristic is evaluated at the time of the analysis/performance evaluation. For the character evaluation, a scattering (S) parameter expressing the frequency characteristic of the distributed constant circuit is widely used. For the analysis/performance evaluation, an eye pattern, time domain reflectometry (TDR) method or the like are also widely used. The eye pattern is used to check a signal waveform and the TDR method is used to measure the characteristic impedance of a transmission path.

The S parameter indicates the relationship between input and output of a circuit and is usually obtained by an actual measurement or three-dimensional electro-magnetic field analysis. A four-port (terminal) circuit can be expressed, for example, by the block 1201 of the black-box shown in FIG. 2. Since the block 1201 represents a four-port circuit, it is also called a four-port circuit hereinafter. “1”-“4” described in FIG. 2 are numbers assigned to each port for convenience' sake. Therefore, when referring a specific port, a number is attached as in “port 1”. This also applies to other Figs.

In the four-port circuit 1201 shown in FIG. 2, each port has some relationship between input and output. For example, a signal is inputted to “port 1”, a signal is outputted to each of port 1, port 3 and ports 2 and 4 by reflection, transmission and crosstalk, respectively. Thus, a signal is inputted/outputted to/from each port, as shown in FIG. 3. In FIG. 3, “a”, “b” represent an input signal and an output signal, respectively, and “1”-“4” which are attached to it as an affix represent port numbers. Thus, for example, “a₁” indicates the input signal of port 1. This also applies to other symbols. aᵢ and bᵢ (=integer of 1, 2, 3 or 4) are defined by voltage/Z₀^{1/2} or current×Z₀^{1/2}. Z₀ is characteristic impedance.

When a signal is inputted/outputted as shown in FIG. 3, a complex matrix composed of S parameters can be expressed as follows.

$$S = ( \begin{matrix}S 11 & S 12 & S 13 & S 14 \\ S 21 & S 22 & S 23 & S 24 \\ S 31 & S 32 & S 33 & S 34 \\ S 41 & S 42 & S 43 & S 44\end{matrix} ) \qquad ( 1 )$$

In equation (1), S represents a complex matrix and S parameters constituting the complex matrix are attached by two-digit number and described. Of the two digits, numbers located on the left and right sides indicate the port numbers from which a signal is outputted and to which a signal is inputted, respectively. Thus, for example, when a signal is inputted/outputted as shown in FIG. 2, specifically, a signal is transmitted only between ports 1 and 3, and between ports 2 and 4, and there is no other direct transmission, each S parameter expresses the followings. This is described in detail using several examples.

“S11”, “S21”, “S31” and “S41” are parameters in the case where a signal is inputted to port 1. “S11”, “S21”, “S31” and “S41” indicate reflection (ratio of reflected signal to input signal), near-end crosstalk (ratio of signal outputted from port 2), transmission (ratio of signal transmitted from port 1 to port 3 (passing loss) and far-end crosstalk (ratio of signal outputted from port 4), respectively.

“S22”, “S12”, “S32” and “S42” are parameters in the case where a signal is inputted to port 2. “S22”, “S12”, “S32” and “S42” indicate reflection (ratio of reflected signal to input signal), near-end crosstalk (ratio of signal outputted from port 1), far-end crosstalk (ratio of signal outputted from port 3) and, transmission (ratio of signal transmitted from port 2 to port 4 (passing loss) respectively. Thus, each S parameter expresses power magnitude relationship between ports. Similarly, it also expresses phase relationship between ports.

The complex matrix S depends on the characteristic impedance of each port. The characteristic impedance varies depending on the frequency of a signal. Therefore, the complex matrix S (S parameter) is prepared for each frequency. FIG. 4 shows examples of parameters prepared according to frequency. The S parameter is for the four-port circuit 1201 in the case where a signal is inputted/outputted as in shown in FIG. 3, and is stored a file in one text format (touch-stone format).

In FIG. 4, “#HZ S MA R50” that is described on top has the following meanings for each symbol separated by blank.

“HZ” indicates frequency unit. A numeric value indicating each frequency is described as “1.000000e+007”, “2.000000e+007” or “3.000000e+007” on the left side. For example, “1.00000e+007” indicates that the frequency 10 MHz.

“S” indicates that a parameter type is S. Instead of an S parameter, a Z or Y parameter can be stored. “MA” indicates the type of an S parameter. More specifically, “M” and “A” indicate “magnitude” and “angle”, respectively. Both of them are expressed using a predetermined power value or phase as the reference. As other combined symbols, there are “RI” indicating the combination of “real” and “imaginary”, “DB” indicating the combination of “magnitude” and “angle” expressed in units of dB and the like. “R50” indicates the value of terminating resistor. In this case, it is indicated that the resistance value is 50 ohms.

“!” described in FIG. 4 indicates that there is a comment sentence. The S parameters of each frequency are stored after the comment sentence. Since, as described above, there are the absolute value and phase of each S parameter, 16 sets of numeric values are stored for each frequency as its S parameter.

An S parameter and a T parameter can be converted in both directions (Japanese Patent Application No. 2005-274373, hereinafter called “Patent reference 1”). As shown in FIG. 5, the S parameter indicates the input/output relationship of a signal in a device, while the T parameter focuses the port position of a device and indicates the input/output relationship of a signal, between the left side (usually, input side) and right side (usually, output side) of a device. Therefore, as shown, for example, in FIG. 6, the T parameter can evaluate the characteristic of a circuit connecting an A circuit 1601 and a B circuit 1602, both of which are the four-port circuit. FIG. 6 shows that in order to evaluate the characteristic of the circuit obtained by connecting these circuits 1601 and 1602, an output signal from one circuit is handled as an input signal to the other circuit between the ports 3 and 4 of the A circuit 1601 and between ports 1 and 2 of the B circuit 1602. Therefore, the input/output relationship of a signal in the connected circuit can be calculated as follows. In the equation and FIG. 6, “T_{A}” and “T_{B}” indicate 4×4 complex matrixes composed of the T parameters of the A and B circuits 1601 and 1602, respectively.

$$( \begin{matrix}{b}_{1 A} \\ {b}_{2 A} \\ {a}_{1 A} \\ {a}_{2 A}\end{matrix} ) = {T}_{A} \cdot {T}_{B} ( \begin{matrix}{a}_{3 B} \\ {a}_{3 B} \\ {b}_{4 B} \\ {b}_{4 B}\end{matrix} ) \qquad ( 2 )$$

As clearly seen from equation (2) and FIG. 6, if a T parameter is used, more circuits can be connected and one or more circuits can be separated from a plurality of circuits by matrix calculation. For example, when a C circuit, which is a four-port circuit, is added and is connected to the B circuit 1602, the T parameter (complex matrix T) of the entire circuit can be calculated as follows.

T=T_{A}·T_{B}·T_{C} (3)

There are conventionally some parameter calculation device that focuses on this fact and calculates the S parameter of a circuit obtained by connecting a plurality of circuits by calculating the T parameter of the circuit and converting the calculated T parameter into an S parameter. The conventional parameter calculation device is disclosed, for example, by Patent reference 1. The S parameter of a connected circuit is hereinafter called “synthesis S parameter” in order to discriminate this parameter from that of a device.

There is the relationship shown in FIG. 5 between an S parameter and a T parameter. Therefore, they are converted between them by deriving out a relation equation between the S and T parameters for each element from a matrix equation.

The higher the hierarchical order is, the more complex the relation equation becomes. For the simplification of an equation, the relation equation is described using the two-port circuit 1801 shown in FIG. 8 as an example.

In this case, a 2×2 complex matrix composed of T parameters can be expressed as follows.

$$[ \begin{matrix}{b}_{2} \\ {a}_{1}\end{matrix} ] = [ \begin{matrix}T 11 & T 12 \\ T 21 & T 22\end{matrix} ] [ \begin{matrix}{a}_{2} \\ {b}_{1}\end{matrix} ] \qquad ( 4 )$$

A 2×2 complex matrix composed of S parameters can be expressed as follows.

$$[ \begin{matrix}{b}_{1} \\ {b}_{2}\end{matrix} ] = [ \begin{matrix}S 11 & S 12 \\ S 21 & S 22\end{matrix} ] [ \begin{matrix}{a}_{1} \\ {a}_{2}\end{matrix} ] \qquad ( 5 )$$

Each of the T and S parameters shown in equations (4) and (5) can be calculated as follows.

$$\begin{matrix}[ \begin{matrix}T 11 & T 12 \\ T 21 & T 22\end{matrix} ] = [ \begin{matrix}- ( S 11 \cdot S 22 - S 12 \cdot S 21 ) / S 21 & S 11 / S 21 \\ - S 22 / S 21 & 1 / S 2 \; 1\end{matrix} ] & ( 6 ) \\ [ \begin{matrix}S 11 & S 12 \\ S 21 & S 22\end{matrix} ] = [ \begin{matrix}T 12 / T 22 & ( T 11 \cdot T 22 - T 1 \; 2 \cdot T 21 ) / T 22 \\ 1 / T 22 & - T 21 / T 22\end{matrix} ] & ( 7 )\end{matrix}$$

Since, as described above, the complex matrix S (S parameter) depends on the characteristic impedance of each port provided in a device, the complex matrix S is prepared for each frequency. By using the S parameter prepared for each frequency, a graph indicating the relationship between “magnitude (power absolute value)” and “frequency” shown in FIG. 7 can be drawn. The graph, can be, for example, obtained from an S parameter S31 in the four-port circuit 1201 shown in FIG. 3. Its horizontal and vertical axes indicate “frequency” and “magnitude”, respectively. The existence of a resonance point and a signal loss state can be read.

The characteristic impedance of each port varies depending on a device (circuit). Therefore, the manufacturer of a device or the like must provide its purchaser with the S parameter of a purchased device. Currently some manufacturer can provide it via the Internet.

The provider side of an S parameter determines a frequency whose S parameter must be provided for each device by its determination. Therefore, a frequency whose S parameter is provided usually varies depending on a device.

As shown in FIG. 4, the S parameter varies depending on a frequency. Therefore, the characteristic of a device must be evaluated for each frequency. However, a frequency whose S parameter is prepared in a device used in a product usually varies depending on a device. In a connected circuit, all the frequencies of S parameters constituting it must be the same. Thus, the frequency of an S parameter prepared for each device must be limited to a frequency that can evaluate its characteristic.

The provision of an S parameter with a necessary frequency can be requested for a manufacturer or the like. However, it takes a fairly long time to actually provide such an S parameter. As a result, product development delays according to a time needed to provide a requested S parameter. As shown in FIG. 7, there is also a frequency that should not be adopted. Taking this into consideration, in order to promote more rapid product development, it is important to appropriately cope with the limit. This also applies to other parameters prepared for each frequency for the characteristic evaluation.

As another reference literature, Japanese Patent Application No. 2002-318256 is picked up.

### SUMMARY OF THE INVENTION

It is an object of the present invention to provide a technology for appropriately coping with characteristic evaluation limited by the difference of the frequency of the parameters prepared for each device.

The parameter calculation apparatus of the present invention aims to calculate a parameter indicating the characteristic of a circuit to be prepared for each frequency, and comprises a parameter acquisition unit for obtaining a plurality of existing parameters whose frequency is different, a frequency selection unit for selecting a frequency whose parameter is calculated and a parameter calculation unit for calculating a parameter by the frequency obtained by the frequency selection unit, using the plurality of existing parameters with different frequencies, obtained by the parameter acquisition unit.

The parameter calculation method of the present invention calculates a parameter indicating the characteristic of a circuit to be prepared for each frequency, and comprises obtaining a plurality of existing parameters whose frequency is different, selecting a frequency whose parameter is calculated and calculating the parameter of the frequency selected by the selection function, using the plurality of existing parameters with different frequencies.

The storage medium of the present invention can be accessed by a computer used as the parameter calculation apparatus for calculating a parameter indicating the characteristic if a circuit to be prepared for each frequency, and stores a program, the program comprises a parameter acquisition function for obtaining a plurality of existing parameters whose frequency is different, a frequency selection function for selecting a frequency, the parameter of which should be calculated, and a parameter calculation function for calculating the parameter in a frequency selected by the frequency selection function, using the plurality of existing parameters obtained by the parameter acquisition function.

The present invention obtains a plurality of existing parameters with different frequencies, selecting a frequency whose parameter is calculated and calculating the parameter of the selected frequency, using the plurality of existing parameters with different frequencies. Thus, at least one of parameters obtained by connecting a circuit (device) from which an existing parameter is obtained and a plurality of such a circuit or the circuit obtained by connecting a plurality of types of circuits is newly generated. Specifically, at least one of parameters whose frequency is not prepared in a circuit and a parameter to be prepared in a connected circuit is newly generated.

When generating a parameter whose frequency is not prepared in a circuit, a characteristic can be rapidly evaluated by a frequency that generates a parameter. When generating a parameter to be prepared in a connected circuit, the characteristic of the connected circuit can be rapidly evaluated. Therefore, in either case, a user can appropriately correspond to a frequency by which a characteristic restricted by the difference in frequency among parameters prepared for each device can be evaluated.

### BRIEF DESCRIPTION OF THE DRAWINGS

FIG. 1 shows the general flow of electric product development;

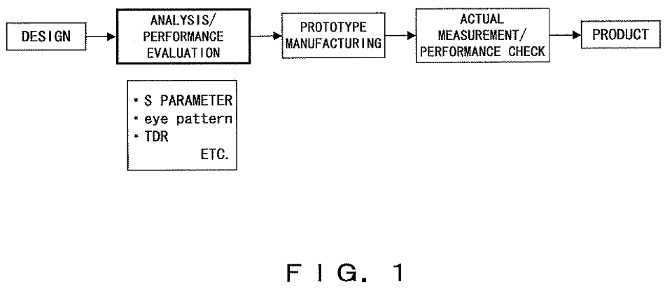

FIG. 2 shows an example of the expression of a four-port circuit;

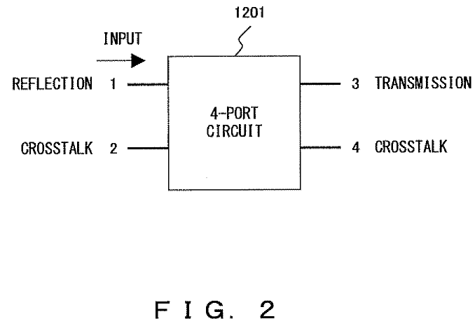

FIG. 3 shows the input/output of a target signal in the four-port circuit;

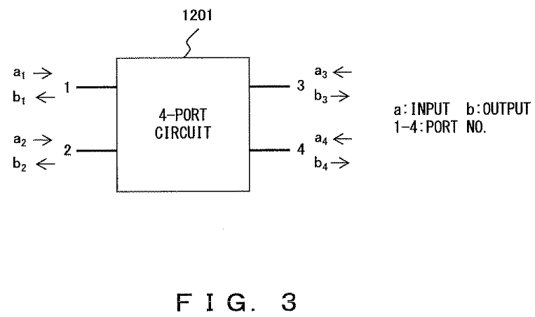

FIG. 4 shows examples of S parameters prepared for each frequency;

FIG. 5 shows the difference in relationship between S and T parameters;

FIG. 6 shows how to measures of the connection of a plurality of devices;

FIG. 7 is a graph that can be drawn using an S parameter;

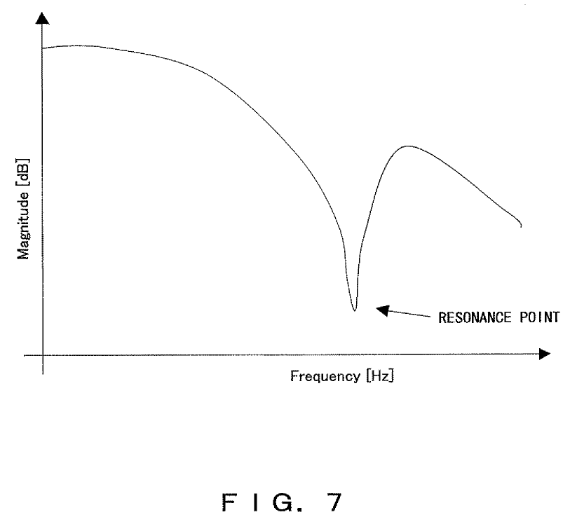

FIG. 8 shows an example of the expression of a two-port circuit;

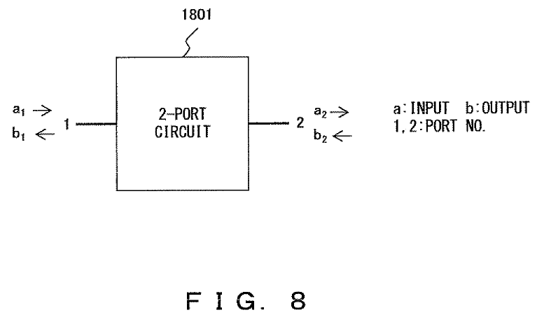

FIG. 9 shows the functional configuration of the parameter calculation apparatus in this preferred embodiment;

FIG. 10 shows an existing frequency whose S parameter is prepared for each device;

FIG. 11 shows a frequency whose S parameter is calculated in each device;

FIG. 12 shows how to store a calculated S parameter;

FIG. 13 shows a frequency whose S parameter is calculated when A and B devices are connected;

FIG. 14 shows a frequency whose S parameter is calculated, other than a common frequency in a circuit obtained by connecting A and B devices;

FIG. 15 is the flowchart of a first parameter calculation process;

FIG. 16 is the flowchart of a second parameter calculation process;

FIG. 17 is the flowchart of a third parameter calculation process; and

FIG. 18 shows an example of the hardware configuration of a computer that can realize the parameter calculation apparatus of this preferred embodiment.

### DESCRIPTION OF THE PREFERRED EMBODIMENTS

The preferred embodiments of the present invention are described in detail below with reference to the drawings.

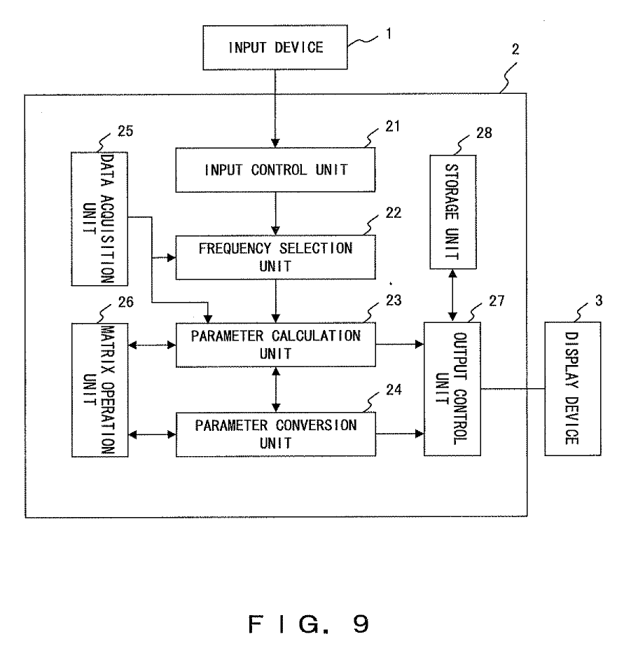

FIG. 9 shows the functional configuration of the parameter calculation apparatus in this preferred embodiment. The parameter calculation apparatus (hereinafter called “calculation apparatus”) 2 calculates (generates) a different S parameter using an existing S parameter. In this preferred embodiment, according to the instruction of a user (an evaluator for evaluating a characteristic or operator), issued by the user's operation of an input device 1, an S parameter to be calculated can be calculated, and displayed on a display device 3.

The input device 1 connected to the calculation apparatus 2 comprises a pointing device, such as a mouse or the like, and a keyboard. The display device 3 is, for example, a liquid crystal (LC) display device or the like. The calculation apparatus 2 comprises an input control unit 21, a frequency selection unit 22, a parameter calculation unit 23, a parameter conversion unit 24, a data acquisition unit 25, a matrix operation unit 26, an output control unit 27 and a storage unit 28. Each of these units 21-28 is as follows.

The input control unit 21 detects an operation that an operator applies to the input device 1 and recognizes the instruction of the operator. The frequency selection unit 22 selects a frequency whose S parameter to be calculated. The parameter calculation unit 23 calculates the S parameter of the frequency selected by the frequency selection unit 22. The parameter conversion unit 24 converts both directions between S and T parameters. The data acquisition unit 25 obtains a variety of data, including an existing s parameter for each device. The output control unit 27 accesses an image on the display device 3 and the storage unit 28. The storage unit 28 is a non-volatile storage device for storing data.

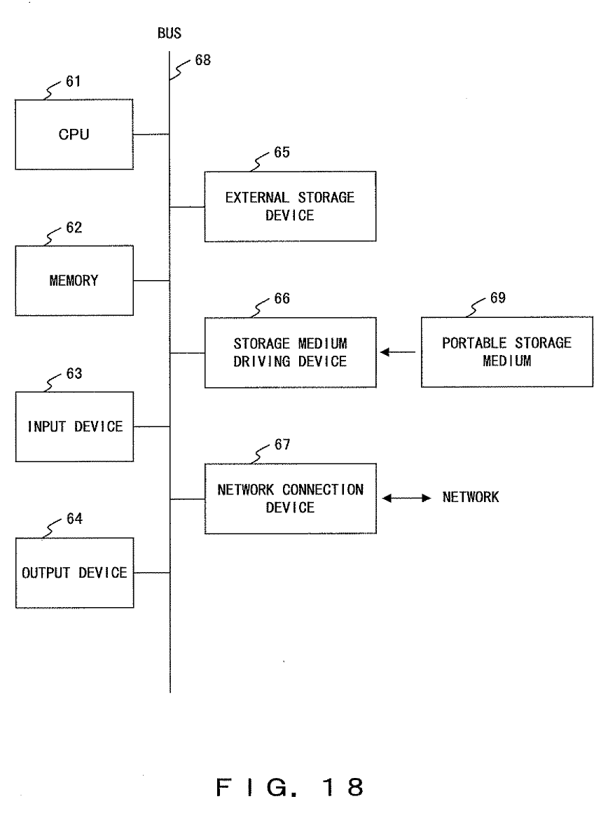

FIG. 18 shows an example of the hardware configuration of a computer for realizing the calculation apparatus 2. Prior to the detailed description of FIG. 9, the configuration of the computer for realizing the calculation apparatus 2 is described in detail. In order to avoid complexity, it is assumed that the calculation apparatus 2 is realized by one computer whose configuration is shown in FIG. 18.

The computer shown in FIG. 18 comprises a central processing unit (CPU) 61, memory 62, an input device 63, an output device 64, an external storage device 65, a storage medium driving device 66 and a network connection device 67, which are connected to each other by a bus 68. The configuration shown in FIG. 18 is one example and the configuration is not limited to this.

The CPU 61 controls the entire computer.

The memory 62 is memory, such as RAM or the like, for temporarily storing a program or data stored in the external storage device 65 (or a portable storage medium 69) when executing the program updating the data or the like. The CPU 61 controls the entire computer by reading the program into the memory 62 and executing it.

The input device 63 is an interface connected to the input device 1, such as a keyboard, a mouse or the like, or comprises all the devices. The input device 63 detects an operation that a user applies to the input device 1 and notifies the CPU 61 of the detection result.

The output device 64 is a display control device connected, for example, to the display device 3 shown in FIG. 9 or comprises both of them. The output device 64 outputs data transmitted by the control of the CPU 61 on the display device 3 shown in FIG. 9.

The network connection device 67 communicates with an external device via a network, such as an intranet, the Internet or the like. The external storage device 65 is, for example, a hard disk device. The external storage device 65 is mainly used to store a variety of data and programs.

The storage medium driving device 66 accesses a portable storage medium 69, such as an optical disk, a magneto-optical disk or the like.

The calculated S parameter is, for example, in the memory 62 or the external storage device 65 alone or together with an existing S parameter. The existing S parameter is obtained from the storage medium 69, for example, by the storage medium driving device 66 or from an external device via the network connection device 67, and is stored on the storage medium 69 that can be accessed by the storage medium driving device 66. In this preferred embodiment it is assumed for convenience' sake that any S parameter is stored in the external storage device 65.

The calculation apparatus 2 by this preferred embodiment can be realized by the CPU 61 executing a program mounting functions needed to calculate a parameter (hereinafter called “parameter calculation software”). The calculation software can be recorded on the storage medium 69 and be distributed. Alternatively it can be obtained by the network connection device 67. In this case, it is assumed to be stored in the external storage device 65.

On the above-described assumption, the input control unit 21 can be realized, for example, by the CPU 61, the memory 62, the external storage device 65 and the bus 68. The data acquisition unit 25 can be realized, for example, by the CPU 61, the memory 62, the external storage device 65, the storage medium driving device 66, the network connection device 67 and the bus 68. The output control unit 27 can be realized, for example, by the CPU 61, the memory 62, the output device 64, the external storage device 65 and the bus 68. The storage unit 28 corresponds to the external storage unit 65.

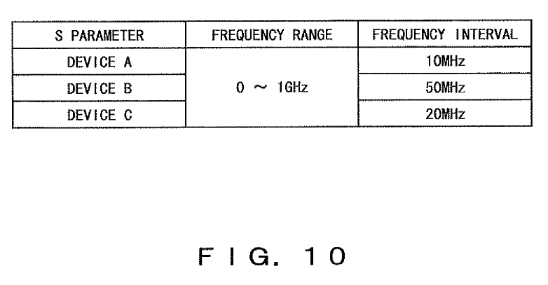

This preferred embodiment selects a frequency whose S parameter to be calculated and calculates the S parameter of the selected frequency, as follows. This is described in detail for each case with reference to FIGS. 10-14.

FIG. 10 shows an existing frequency whose S parameter is prepared for each device. It shows using three devices A-C as examples that in the device A, an S parameter is prepared every 10 MHz in the frequency range of 0-1 GHz, in the device B, every 50 MHz and in the device C, every 20 MHz. Hereinafter, it is assumed in order to avoid complexity that S parameters are prepared in three devices A-C thus, as long as otherwise mentioned.

As shown in FIG. 10, a frequency whose S parameter is prepared usually varies depending on a device. Therefore, in this preferred embodiment, a frequency whose S parameter is not prepared in one or more of target devices (devices A-C in this case) is selected and an S parameter can be calculated in a device where the S parameter of the frequency. Thus, a state where there are the S parameters of all the devices can be realized in a frequency whose S parameter is prepared in one or more of the target devices. The input control unit 21 for recognizing the instruction contents of the user via the input device 1 determines whether it should be realized.

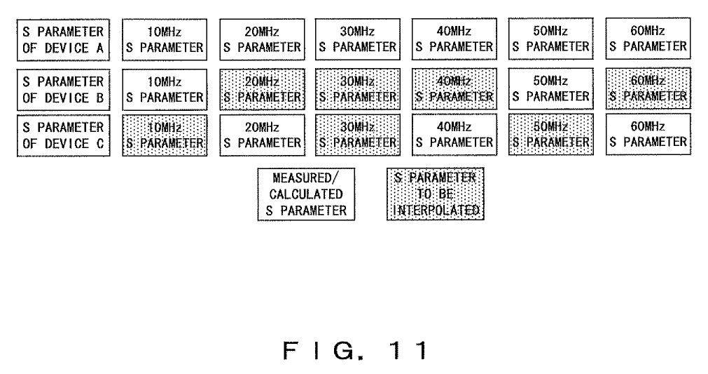

FIG. 11 shows a frequency whose S parameter is calculated in each device. In FIG. 11, a frequency whose S parameter is calculated is meshed and a frequency whose existing S parameter there is not meshed. The existing S parameter is provided by a manufacturer or the like or is previously calculated. These are described as a “measured or calculated S parameter” in FIG. 11, and an S parameter to be calculated is described an “interpolated S parameter”. Thus, FIG. 11 shows that in the device A, an S parameter is calculated in no frequency, in the device B, an S parameter, in 20-40 and 60 MHz and in the device C, in 10, 30 and 50 MHz. Similarly, in a frequency higher than 60 MHz, excluding a frequency of 100×n (n: integer between 1 and 100), an S parameter is calculated in at least one of the devices B and C in a frequency whose S parameter is prepared in the device A.

Thus, by calculating an S parameter, a frequency that cannot evaluate the characteristic since a frequency whose S parameter is prepared varies for each device can be surely avoided from occurring. Therefore, the characteristic can be evaluated in all frequencies where an existing S parameter is prepared in at least one of the devices A-C. Thus, there becomes no need to request a manufacturer or the like to provide a necessary S parameter, thereby promoting more rapid product development.

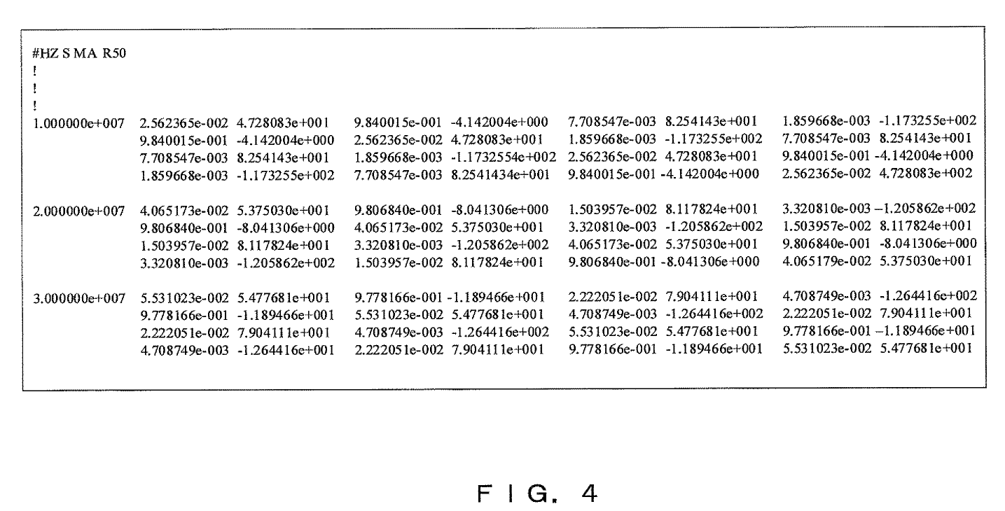

The data acquisition unit 25 obtains an S parameter for each device in the file format shown in FIG. 4. The frequency selection unit 22 refers to the file obtained by the data acquisition unit 25, selects a frequency whose S parameter to be calculated for each device and notifies the parameter calculation unit 23 of the selection result. Thus, the calculation unit 23 calculates the S parameter of the notified frequency for each device.

In this preferred embodiment, an S parameter is calculated by linear interpolation. Thus, for example, when calculating an S parameter in 30 MHz on the basis of the S parameter in 20 MHz and 40 MHz, the S parameter in 30 MHz can be calculated as follows. Complex matrixes S_{20M} and S_{40M} composed of the S parameters in 20 MHz and 40 MHz, respectively are shown below.

$$\begin{matrix}{S}_{20 M} = ( \begin{matrix}S {11}_{20 M} & S {12}_{20 M} & S {13}_{20 M} & S {14}_{20 M} \\ S {21}_{20 M} & S {22}_{20 M} & S {23}_{20 M} & S {24}_{20 M} \\ S {31}_{20 M} & S {32}_{20 M} & S {33}_{20 M} & S {34}_{20 M} \\ S {41}_{20 M} & S {42}_{20 M} & S {43}_{20 M} & S {44}_{20 M}\end{matrix} ) & ( 8 ) \\ {S}_{40 M} = ( \begin{matrix}S {11}_{40 M} & S {12}_{40 M} & S {13}_{40 M} & S {14}_{40 M} \\ S {21}_{40 M} & S {22}_{40 M} & S {23}_{40 M} & S {24}_{40 M} \\ S {31}_{40 M} & S {32}_{40 M} & S {33}_{40 M} & S {34}_{40 M} \\ S {41}_{40 M} & S {42}_{40 M} & S {43}_{40 M} & S {44}_{40 M}\end{matrix} ) & ( 9 )\end{matrix}$$

It is assumed that an S parameter indicates “magnitude (power absolute value)” and “phase”. Since the S parameter is complex, the S parameters in 20 MHz and 40 MHz are expressed as follows, for example, if S11 is used as an example. In the equations, Mag and Phase represent magnitude and phase, respectively, and affixes 20M and 40M indicate frequencies. Hereinafter, the same applies.

S11_{20M}=(Mag11_{20M},Phase11_{20M}) (10)

S11_{40M}=(Mag11_{40M},Phase11_{40M}) (11)

A straight line passing through two points of y₁ and y₂ in the cases of x₁ and x₂ can be expressed as follows.

y=(y₂−y₁)·(x−x₁)/(x₂−x₁)+y₁ (12)

If equation (12) is used, Mag11_{30M} in the case of 30 MHz can be calculated by assigning x₁=20x₂=40, x=30, y₁=Mag11_{20M} and y₂=Mag11_{40M}. Phase11_{30M} can be calculated by changing the assigned numeric values to y₁=Phase11_{20M} and y₂=Phase11_{40M}. Thus, “magnitude” and “phase” in the case of 30 MHz can be calculated for each S parameter.

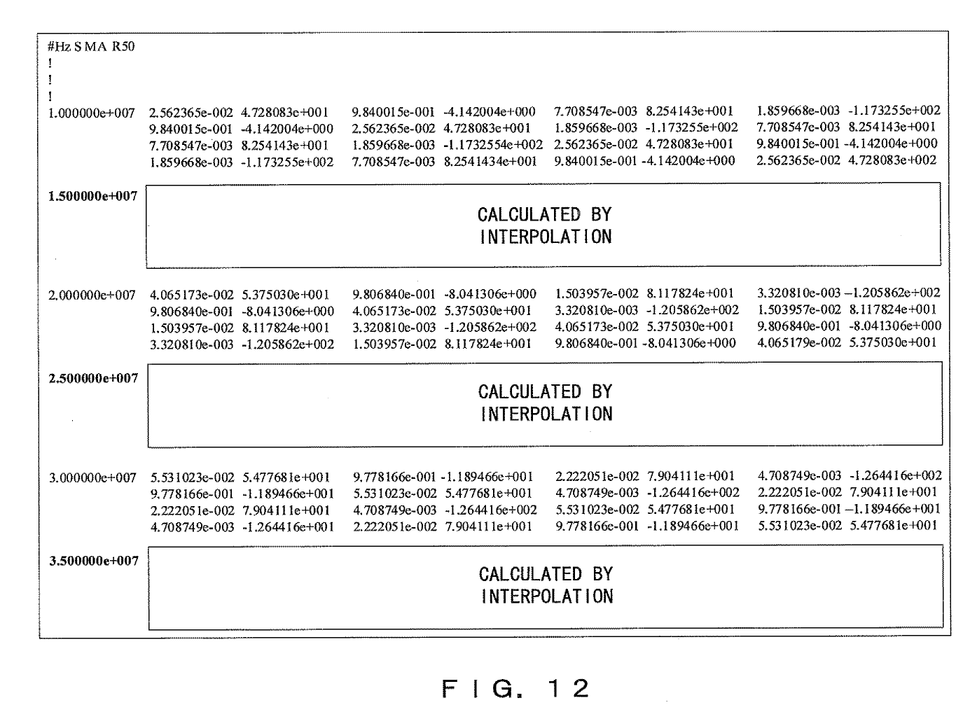

FIG. 12 shows how to store the calculated S parameter.

In this preferred embodiment, the calculated S parameter is stored together with an existing S parameter as one file. As shown in FIG. 12, the calculated S parameter is located and stored in a position corresponding to its frequency. Thus, if an S parameter is obtained in the file format shown in FIG. 4, its updated file is newly stored. The S parameter is transmitted from the parameter calculation unit 23 to the output control unit 27 in a file format and is stored in the storage unit 28.

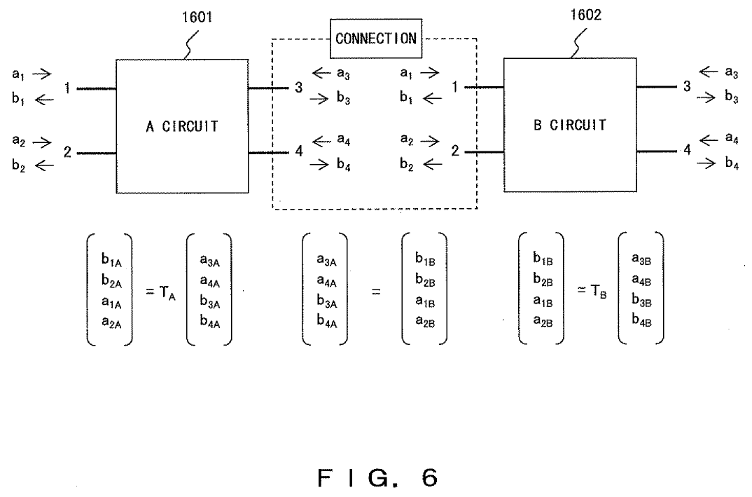

In the above case, a frequency whose S parameter to be newly prepared for each device is selected and the S parameter is calculated (hereinafter called “individual case”). In this case, it is assumed that the characteristic of a device can be individually evaluated. However, as shown in FIG. 6, a plurality of devices is often connected. In the case described next, a circuit obtained by connecting a plurality of devices is assumed.

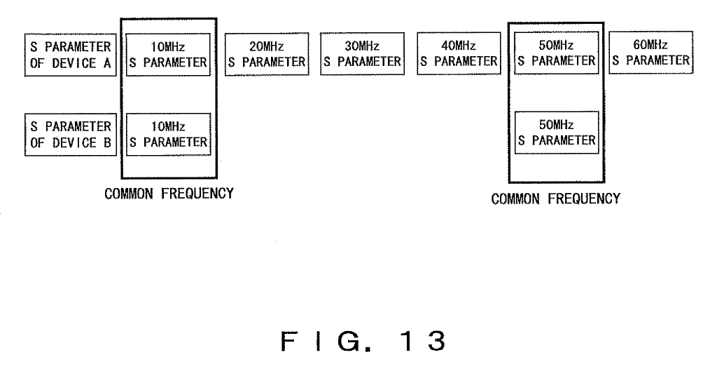

FIG. 13 shows a frequency whose S parameter is calculated when devices A and B are connected. In that case, as shown in FIG. 13, the S parameter of a circuit obtained by connecting devices A and B is calculated in a frequency where there is an existing S parameter in both of them (common frequency). Hereinafter, the S-parameter calculation of the connected circuit is also described as “to connect S parameters”.

In the common frequency, there is an S parameter in all devices. Therefore, in the common frequency, the characteristic can be evaluated without newly calculating an S parameter. By calculating the S parameter of a circuit obtained by connecting a plurality of devices (synthesis S parameter), the characteristic of the connected circuit can be more rapidly evaluated in the common frequency. It is because there is a possibility that an error exists in a newly calculated S parameter that the characteristic is evaluated in the common frequency. Specifically, it is because a frequency in which the characteristic can be evaluated more accurately is thought as important.

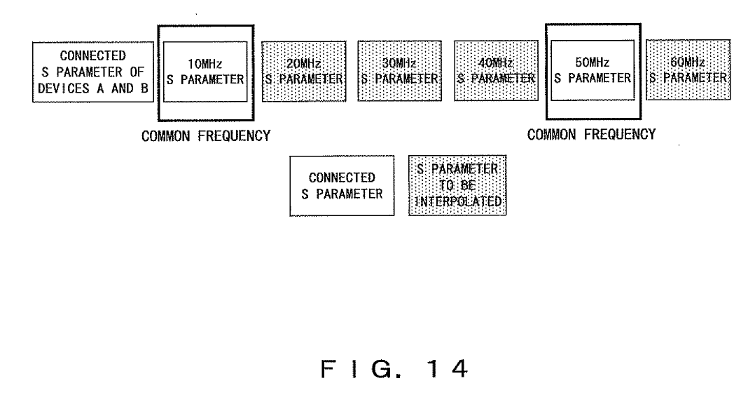

However, the characteristic must be often evaluated in frequencies other than the common frequency. Therefore, in this preferred embodiment, as shown in FIG. 14, a synthesis S parameter can be calculated in frequencies other than the common frequency. It is calculated by linear interpolation using a synthesis S parameter obtained in a plurality of common frequencies, as in the case of a device. It is because the characteristic can be evaluated in all frequencies whose existing S parameter is prepared in at least one of the devices A-C, as shown in FIGS. 10 and 11 that a synthesis S parameter is calculated in 20, 30 and 40 MHz by the linear interpolation. Specifically, it is because a frequency other than a common frequency whose existing S parameter is prepared in at least one of the devices A-C is selected as a frequency whose combined parameter should be calculated separately. It is in order to suppress an error caused by the calculation that a synthesis S parameter is not calculated using the calculated S parameter of the device B.

Since another synthesis S parameter is calculated on the basis of a combined parameter by interpolation, a frequency, another synthesis S parameter of which is calculated is calculated by interpolation. When there is no need to evaluate the characteristic for each device constituting a connected circuit, the frequency of a synthesis S parameter calculated by interpolation can also be selected without taking into consideration frequencies other than a common frequency whose S parameter is prepared in a device.

A synthesis S parameter calculated in a common frequency is stored as a new file. When another S parameter is calculated on the basis of a synthesis S parameter, they are stored as one file (FIG. 12). Hereinafter, the case where a synthesis S parameter is calculated only in a common frequency is called “first connection case”, and the case where a synthesis S parameter is also calculated in frequencies other than a common frequency is called “second connection case”.

The input control unit 21 shown in FIG. 9 recognizes the instruction contents of a user via the input device 1 and operates the calculation apparatus 2 according to the recognition result. If the user's instruction of an S parameter in the first connection case is recognized, the input control unit 21 notifies the frequency selection unit 22 of the recognition result. Upon receipt of the notice, the frequency selection unit 22 refers to a file obtained by the data acquisition unit 25, extracts a common frequency and notifies the parameter calculation unit of it.

Although a user can specify a device to be connected, a connection relation among devices can be automatically specified on the basis of design data. Thus, a device to be connected can also be automatically determined. Alternatively, devices in a connection relation can be extracted and presented, and a user can select a plurality of desired devices of them. Devices to be connected can be determined by a variety of such methods. In the example, only a user's instruction on the calculation case of an S parameter is focused.

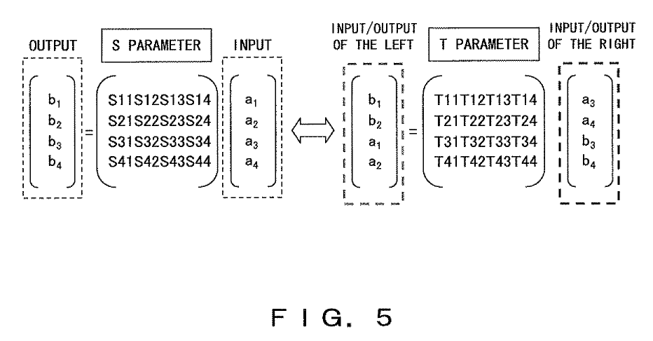

The parameter calculation unit 23 extracts the S parameter of a common frequency notified by the frequency selection unit 22 for each file (device) and transmits it to the parameter conversion unit 24. The parameter conversion unit 24 converts each S parameter (complex matrix) into each T parameter (complex matrix) (FIG. 5) and transmits it to the matrix operation unit 26. The operation unit 26 performs the matrix operation, for example, as shown in equation (2) or (3), for each common frequency according to the types and quantity of connected devices (FIG. 6), and returns a T parameter (complex matrix) obtained by the operation to the parameter conversion unit 24. The parameter conversion unit 24 converts the T parameter into an S parameter (synthesis S parameter) and transmits it to the output control unit 27 in a file format. Then, the synthesis S parameter calculated for each common frequency is stored in the storage unit 28.

The conversion of an S parameter into a T parameter, the conversion of a T parameter into an S parameter and the matrix operation can be performed, for example, by the method disclosed by Patent reference 1. Therefore, the detailed descriptions of those are omitted here.

If the calculation of an S parameter in the second connection case is instructed by a user, the calculation apparatus 2 operates in almost the same way as when the first connection case is instructed by the user. Therefore, only different parts are focused and described below.

After converting a T parameter returned from the matrix operation unit 26 into a synthesis S parameter, the parameter conversion unit 24 transmits the synthesis S parameter to the parameter calculation unit 23. The frequency selection unit 22 selects a frequency whose synthesis S parameter should be calculated in frequency other than a common frequency and notifies the parameter calculation unit 23 of it. Then, the calculation unit 23 calculates a synthesis S parameter for each notified frequency other than the common frequency, and transmits it to the output control unit 27 together with the synthesis S parameter from the parameter conversion unit 24 in a file format. Then, the calculated synthesis S parameter is stored in the storage unit 28 via the output control unit 27.

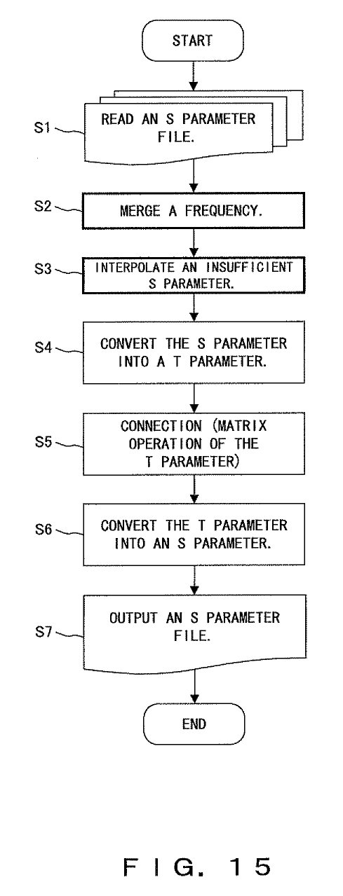

FIGS. 15-17 are the flowcharts of each process performed when an S-parameter calculation is instructed by a user in each of the above-described individual case and first and second connection cases. Next, the operation of the calculation apparatus 2 is described in detail with reference to each flowchart shown in FIGS. 15-17. Any of the processes can be realized by the CPU 61 shown in FIG. 18 reading parameter calculation software stored in the external storage device 65 into the memory 62 and executing it.

FIG. 15 is the flowchart of the first parameter calculation process. The calculation process is performed when the S parameter calculation in the individual case is instructed by a user. Firstly, the calculation process is described in detail with reference to FIG. 15. It is assumed that an S parameter is already stored in the external storage device 65 as a file. The same applies hereinafter.

Firstly, in step S1, the file stored in the external storage device 65 is read and stored in the memory 62. Then, in step S2, by referring to the read file, a frequency whose S parameter to be prepared is extracted for each file (device) and is merged. By the merger, all frequencies whose S parameter should be prepared in one or more of devices are specified.

Then, in step S3, a frequency whose S parameter should be calculated is selected for each device (file) from the frequencies whose S parameters are prepared for each file and merged frequencies (FIG. 11), and the S parameter of a frequency selected for each file is calculated by interpolation. Then, in step S4, the S parameter of each device is converted into a T parameter for each frequency. Then, in step S5, a matrix operation using a T parameter is performed to calculate the T parameter of the circuit obtained by connecting devices to be connected (FIG. 6). Then, the process proceeds to step S6.

In step S6, the newly calculated T parameter of the connected circuit is converted into a synthesis S parameter. Then, in step S7, the file in which the S parameter calculated in step S3 is inserted, shown in FIG. 12 and the file in which the calculated synthesis S parameter is stored for each connected circuit, are stored in the external storage device 65 and the result is outputted to the display device 3. Then, the series of processes are terminated.

As described above, in this preferred embodiment, the synthesis S parameter of a connected circuit is calculated even in the case of the individual case. Since the S parameter of each device is as shown in FIG. 11, there is a possibility that the accuracy of the synthesis S parameter may be lower than that in the case where it is calculated using a synthesis S parameter obtained in a common frequency.

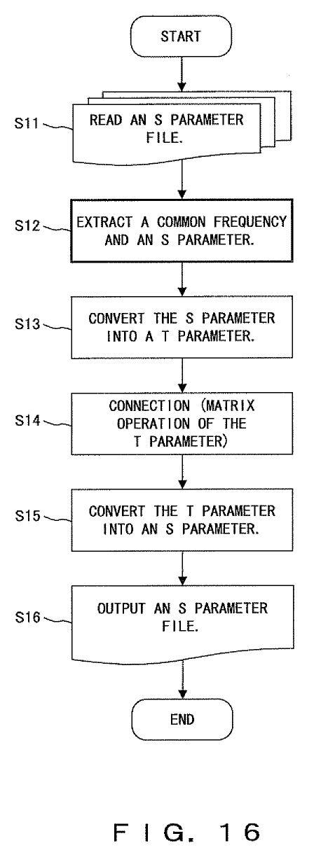

FIG. 16 is the flowchart of the second parameter calculation process. This calculation process is performed when the S-parameter calculation in the first connection case is instructed by a user. Next, the calculation process is described in detail with reference to FIG. 16.

Firstly, in step S11, a file stored in the external storage device 65 is read and is stored in the memory 62. Then, in step S12, by referring the read file, a common frequency whose S parameter to be prepared is extracted for each file (device) and the S parameter of the common frequency is extracted from each file. Then, the process proceeds to step S13.

In step S13, the S parameter of the common frequency, extracted for each file is converted into a T parameter. Then, in step S14, a matrix operation using the T parameter is performed to calculate the T parameter of a circuit obtained by connecting devices to be connected (FIG. 6). Then, the process proceeds to step S15.

In step S15, the newly calculated T parameter of the connected circuit is converted into a synthesis S parameter. Then, in step S16, a file in which the synthesis S parameter obtained by conversion is stored for each connected circuit is stored in the external storage device 65 and the result is outputted to the display device 3. Then, the series of processes are terminated.

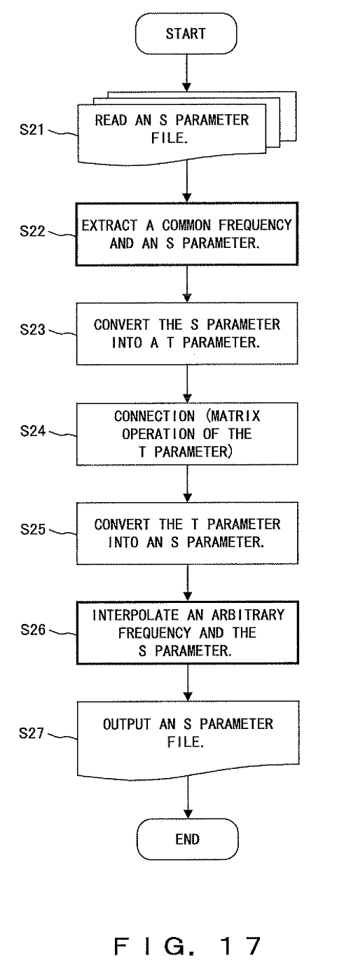

FIG. 17 is the flowchart of the third parameter calculation process. This calculation process is performed when the S parameter calculation in the second connection case is instructed by a user. Next, the calculation process is described in detail with reference to FIG. 17.

The process contents in steps S21-S25 are basically the same those in steps S11-15 shown in FIG. 16. Therefore, the descriptions of those are omitted and only processes in and after step S26 to which the process proceeds after performing the process in step S25.

In step S26, a frequency other than a common frequency is selected by interpolation, and a synthesis S parameter is calculated by interpolation for each selected frequency, using a synthesis S parameter converted in step S25. After the calculation, the process proceeds to step S27. In step S27, a file in which the synthesis S parameters obtained in steps S25 and 26 are stored for each connected circuit is stored in the external storage device 65 and the result is outputted to the display device 3. Then, the series of processes are terminated.

By using an S parameter, not only a frequency characteristic (transmission, reflection and crosstalk) can be evaluated, but the current distribution density and electric field intensity distribution on the surface of a transmission line can also be represented by the three-dimensional model of a device. The size of current that flows over the transmission line can be visually caught from such distribution. By converting an S parameter into a circuit model by inverse Fourier transform and applying simulation program with integrated circuit emphasis (SPICE: circuit analysis simulator developed by University of California) analysis to it, it can be compared with the measurement result of a TDR method and the characteristic impedance and circuit connection of the device can be checked. Since such a variety of characteristics can be evaluated, an S parameter is an important parameter in the characteristic evaluation.

For the above-described reason, in this preferred embodiment, a calculation target is an S parameter. However, instead of the S parameter or in addition to it, a Z (open-circuit impedance) parameter or Y (short-circuit admittance) parameter can be calculated. Alternatively, a T parameter obtained in the course of the calculation of an S parameter can be stored.

Although in this preferred embodiment, a frequency whose S parameter is calculated is automatically selected taking into consideration a frequency whose S parameter is prepared for each device, it is in order to evaluate the characteristic with higher accuracy by giving priority to the use of an already prepared S parameter. Alternatively, in order to evaluate the characteristic in an arbitrary frequency, a user can specify a frequency, a frequency interval, a frequency range or the like and the calculation apparatus 2 can cope with such specification.

What is claimed is:

1. A parameter calculation apparatus for calculating parameters indicting a characteristic of a circuit to be prepared according to frequency, comprising:
a parameter acquisition unit for obtaining a plurality of existing parameters whose frequency is different;
a frequency selection unit for selecting a frequency, the parameter of which should be calculated; and
a parameter calculation unit for calculating the parameter in a frequency selected by the frequency selection unit, using the plurality of existing parameters obtained by the parameter acquisition unit.

2. The parameter calculation apparatus according to claim 1, wherein
the parameter acquisition unit obtains the parameter for each of the circuits and the frequency selection unit selects a frequency for each of the circuits, on the basis of a frequency, the parameter of which is obtained for each of the circuits by the parameter acquisition unit.

3. The parameter calculation apparatus according to claim 1, wherein
the parameter acquisition unit obtains the parameter for each of the circuits,
the parameter calculation unit calculates a synthesis parameter, which is a parameter of a circuit obtained by connecting a plurality of circuits as the parameter and
the frequency selection unit selects a frequency, the synthesis parameter of which should be calculated, on the basis of a frequency, the parameter of which the parameter acquisition unit obtains for each circuit constituting the plurality of circuits.

4. The parameter calculation apparatus according to claim 3, wherein
the frequency selection unit extracts a frequency common among frequencies, the parameters of which the parameter acquisition unit obtains for each circuit constituting the plurality of circuits, and selects a frequency, the synthesis parameter should be calculated.

5. The parameter calculation apparatus according to claim 3, wherein
the frequency selection unit extracts a plurality of frequencies common among frequencies, the parameters of which the parameter acquisition unit obtains for each circuit constituting the plurality of circuits, selects it as a first frequency, the synthesis parameter should be calculated, and selects a frequency that is not common among frequencies, the parameters of which the parameter acquisition unit obtains for each of the circuits, as a second frequency, the synthesis parameter of which should be separately calculated, and
the parameter calculation unit calculates each of the synthesis parameters of the first frequency and calculates a synthesis parameter of the second frequency, using a plurality of synthesis parameters obtained by the calculation.

6. The parameter calculation apparatus according to claim 1, wherein
the parameter is a scattered parameter indicating a characteristic of the circuit.

7. A parameter calculation method for calculating a parameter indicating a characteristic of a circuit to be prepared for each frequency, comprising:
obtaining a plurality of existing parameters whose frequency is different;
selecting a frequency the parameter of which should be calculated; and
calculating the parameter in the selected frequency, using a plurality of obtained existing parameters with the different frequencies.

8. The parameter calculation method according to claim 7, wherein
the parameter is obtained for each of the circuits, and
the frequency is selected for each of the circuits, on the basis of a frequency, the parameter of which is obtained for each of the circuits.

9. The parameter calculation method according to claim 7, wherein
the parameter is obtained for each of the circuits,
a synthesis parameter, which is a parameter of a circuit obtained by connecting a plurality of circuits of the circuits, is selected as the parameter, and
the frequency is selected by selecting a frequency, the synthesis parameter of which should be calculated, on the basis of a frequency, the parameter of which is obtained for each circuit constituting the plurality of circuits.

10. The parameter calculation method according to claim 9, wherein
the frequency is selected by extracting a frequency common among frequencies, whose parameters of which are obtained for each circuit constituting the plurality of circuits and selecting it as a frequency, the synthesis parameter of which should be calculated.

11. The parameter calculation method according to claim 9, wherein
a plurality of frequencies common among frequencies, the parameters of which are obtained for each circuit constituting the plurality of circuits is extracted, it is selected as a first frequency, the synthesis parameter should be calculated and a frequency that is not common among frequencies, the parameters of which the parameter acquisition unit obtains for each of the circuits, as a second frequency, and
each of the synthesis parameters of the first frequency is calculated and a synthesis parameter of the second frequency is calculated using the plurality of synthesis parameters obtained by the calculation.

12. The parameter calculation method according to claim 7, wherein
the parameter is a scattered parameter indicating a characteristic of the circuit.

13. A storage medium can be accessed by a computer that can be used as a parameter calculation apparatus for calculating parameters indicating a characteristic of a circuit to be prepared for each frequency, and stores a program to realize a function, the function comprising:
a parameter acquisition function for obtaining a plurality of existing parameters whose frequency is different;
a frequency selection function for selecting a frequency, the parameter of which should be calculated; and
a parameter calculation function for calculating the parameter in a frequency selected by the frequency selection function, using the plurality of existing parameters obtained by the parameter acquisition function.
